(19) United States
(12) Patent Application Publication
(10) Pub. No.: US 2024/0424938 A1
(43) Pub. Date: Dec. 26, 2024

(54) SECOND LIFE EV BATTERY CONTROLLER

(71) Applicant: Smartville, Inc., Carlsbad, CA (US)

(72) Inventors: William von Novak, San Diego, CA (US); Megan Lloyd, San Diego, CA (US); Trish Tran, Oceanside, CA (US)

(21) Appl. No.: 18/742,609

(22) Filed: Jun. 13, 2024

Related U.S. Application Data
(60) Provisional application No. 63/510,314, filed on Jun. 26, 2023.

(51) Int. Cl. B60L 53/62; B60L 53/66; H01M 10/42; H02J 7/00; H02J 7/34

(52) U.S. Cl. CPC B60L 53/62; B60L 53/66; H01M 10/425; H02J 7/0047; H02J 7/342; H01M 2010/4278; H02J 2207/10; H02J 2207/20

(57) ABSTRACT

Systems, methods, and devices are provided for a battery monitoring system for monitoring an EV battery. The battery monitoring system may comprise a controller electrically connected to a communication port of the EV battery and a power connector of the EV battery. The battery monitoring system may further comprise a controller battery electrically connected to the controller and the EV battery. The controller may be configured to receive power from the controller battery. The controller may configured to intermittently receive power from the power connector of the EV battery and to receive battery information from the communication port of the EV battery.

### CROSS-REFERENCE TO RELATED APPLICATIONS

This application claims priority to, and the benefit of, U.S. Provisional Patent Application No. 63/510,314, filed Jun. 26, 2023 and entitled “SECOND LIFE EV BATTERY CONTROLLER,” which is hereby incorporated by reference herein.

### FIELD OF INVENTION

The present disclosure relates generally to a battery motoring device, and, in particular, to an external battery motoring device which intermittently monitors and receives power from an EV battery.

### BACKGROUND

Electric vehicle (“EV”) batteries, during various points in their life cycle, may benefit from monitoring devices. There are many situations where it would be more efficient and cost effective to ship EV batteries external to (or apart from) an electric vehicle. In these situations, the EV battery may be separated from such monitoring, or such monitoring may be turned off.

In one example embodiment, when an EV has reached the end of its life, it may be necessary to dispose of the EV's battery—i.e., recycle, reuse, or put it in a landfill. However, shipping the batteries can be difficult. The difficulties are in part due to safety risks associated with shipping old EV batteries (especially EV batteries that have been damaged or have an unknown history), which can self-ignite (due to thermal runaway), etc. Moreover, the old EV batteries are heavy and difficult to move. In addition, information about the battery may not be available due to lack of monitoring and/or lack of access to the information during transportation of the EV battery. Thus, there is a need for EV battery monitoring systems which may monitor EV batteries during storage and shipment.

### SUMMARY

In an example embodiment, a battery monitoring system for monitoring an EV battery is disclosed. The system may comprise a controller electrically connected to a communication port of the EV battery and a power connector of the EV battery. The system may further comprise a controller battery electrically connected to the controller and the EV battery. The controller may be configured to receive power from the controller battery. The controller may be configured to intermittently receive power from the power connector of the EV battery and to receive battery information from the communication port of the EV battery.

In an example embodiment, a battery monitoring device for monitoring an EV battery is disclosed. The device may comprise a controller electrically connected a communication port of the EV battery, a power connector of the EV battery, and a controller battery. The controller battery may be configured to receive power from the power connector of the EV battery. The controller may be configured to receive power from the controller battery and intermittently receive power from the power connector of the EV battery. The controller may be configured to receive battery information from the communication port of the EV battery.

In another example embodiment, a method of monitoring an EV battery is disclosed. The method may comprise receiving, by a controller, power from a controller battery. The method may further comprise determining, by the controller, a state of charge of the controller battery. The method may further comprise receiving, by the controller, intermittent power from a power connector of the EV battery, based on the state of charge of the controller battery. The method may further comprise receiving, by the controller, a battery information from a communications port of the EV battery.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1 is a diagram illustrating an example battery monitoring system, in accordance with various embodiments;

FIG. 2 is a three-dimensional rendering illustrating an example battery monitoring system, in accordance with various embodiments; and

FIG. 3 is a flow diagram illustrating an example method, in accordance with various embodiments.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

In accordance with an example embodiment, systems, devices and methods are provided for battery monitoring. In an example embodiment, a shipping/storage controller is attached to a battery. The battery in an example embodiment is an EV battery, though the battery may have been used in any suitable application prior to the contemplated shipping. In an example embodiment, the controller is connected to a controller battery. The controller battery can be configured to provide power to the controller. Moreover, the controller can receive power via a power converter, from the connected battery. The controller battery may also be charged, via the power converter, by the connected battery.

In an example embodiment, the controller is connected to the battery data ports, to facilitate the controller receiving information from the battery and/or to control the battery during shipment. Among other information, the battery controller can receive battery state of health information from the battery. The controller further has information useful to those shipping the battery, and in particular to battery safety information. The controller may be used to receive information from EV batteries, such as Second Life EV (SLEV) batteries. The controller may be connected to a communication device (e.g. a Bluetooth communication device) for communicating with a smartphone or other user interface during the shipment process. These and other advantages are described in more detail below.

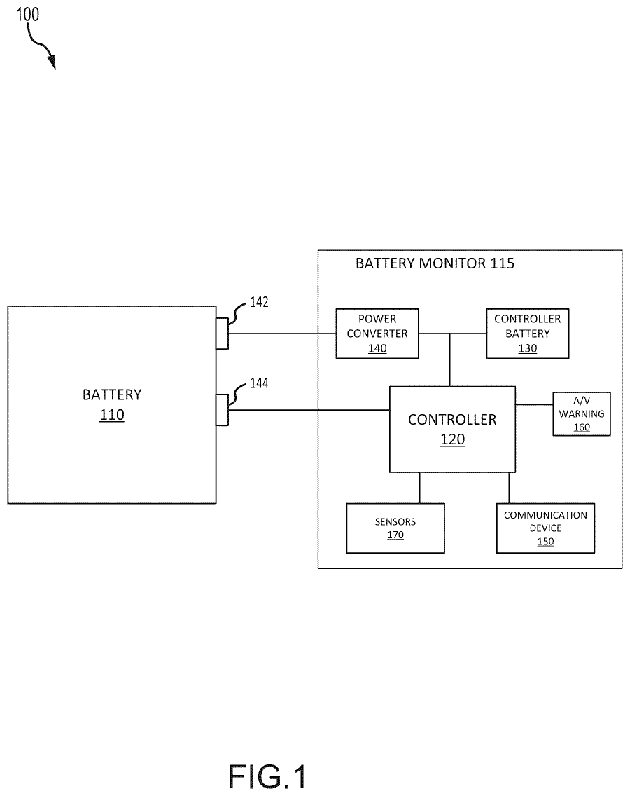

With reference now to FIG. 1, a battery monitoring system 100 is illustrated. The battery monitoring system 100 may comprise battery 110 and battery monitor 115. In an example embodiment, the battery 110 may comprise a power connector 142, and a communication port 144. In various embodiments, the battery 110 may be an EV battery. In various embodiments the battery 110 may comprise lithium ion phosphate (LFP) cells. In other example embodiments, the battery 110 may comprise a lithium ion battery. In various embodiments, the battery 110 may be an EV battery or any suitable battery comprising a communication port 144. In various embodiments, the battery 110 may be in communication with the battery monitor 115 by one or more of the power connector 142, and the communication port 144.

In various embodiments, the battery monitor 115 may comprise a controller 120, a controller battery 130, and a power converter 140. The battery monitor 115 may further comprise various data output or input devices. For example, in various embodiments, the battery monitor 115 may further comprise a communication device 150, and/or an audio video (“A/V”) warning 160.

In various embodiments, the power connector 142 may provide a current output. The power connector 142 may output a high current, high voltage power, ordinarily suitable for driving the traction motors of an EV. The power connector 142 may be electrically connected to the battery monitor 115. The power connector 142 may provide power to the battery monitor 115. In various embodiments, the power connector 142 may be the main power output terminal of the battery 110.

In various embodiments, the communication port 144 may provide information, data, or controls of the battery 110. The communication port 144 may be a data output and/or input device. The communication port 144, in various embodiments, may be a Controller Area Network (“CAN”) data bus or other suitable data communication port 144. The communication port 144 may be electrically connected to the battery monitor 115. In various embodiments, the communication port 144 may send or receive data from the battery monitor 115.

In various embodiments, the battery monitor 115 may comprise a power converter 140. The power converter 140 may be a DC/DC converter or other electrical component capable of receiving a high voltage and outputting a lower voltage. The power converter 140, for example, may receive a 400V output from the power connector 142 and convert the power to 12V. In various embodiments, power converter 140 may output the converted power to the controller 120. The power converter 140 may further output power to the controller battery 130. In various embodiments the power converter 140 may further comprise a switch or other relay. For example, the power converter 140 may be configured to disconnect the power transmitted to the controller 120 and/or the controller battery 130.

In various embodiments, the battery monitor 115 may comprise a controller battery 130. In various embodiments, the controller battery 130 may receive power from the battery 110. The controller battery 130 may receive power from the power converter 140, which has been received from the battery 110. In various embodiments, the controller battery 130 may receive power from an external power source. In various embodiments, the controller battery 130 may be a re-chargeable battery.

In various embodiment, the battery monitor 115 may comprise a controller 120. The controller 120 may receive data from the communication port 144 of the battery 110. The controller 120 may also send data to the battery 110 via the communication port 144. In various embodiments, the controller 120 may be connected to the power converter 140. The controller 120 may receive power from the power converter 140. For example, the power converter 140) may provide a usable voltage, such as 12V of power to the controller 120. The controller 120 may also receive power from the controller battery 130. In various embodiments, the controller 120 may also cause the power converter 140 to intermittently charge battery 130. In various embodiments, the controller 120 may be configured to intermittently and/or selectively receive power from the power connector 142. The controller 120 may normally receive power from the battery 110. For example, at a time interval, the controller 120 may have circuitry to use power from power converter 140 if power is available. For example, at the same time interval, the controller 120 may enable the battery output in order to output power to the battery monitor 115.

In various embodiments, the battery monitor 115 may receive information from the battery 110 via the communication port 144. For example, the controller 120 may receive data and/or signals representative of the current and voltage of the battery 110. The controller 120 may monitor to determine if the temperature is too great, which may indicate thermal runaway. In various embodiments, the controller 120 may monitor the cell voltages of the battery 110 and determine whether the cell voltages are below or above a certain threshold. Additionally, in various embodiments, the controller 120 may determine whether the cell voltage of one cell of the battery 110 is decreasing or dropping much more rapidly than other cell voltages of the battery 110, which would indicate damage or degradation of that cell. In various embodiments, the controller 120 may measure temperature of the battery 110 and/or controller battery 130, to ensure that the battery is not starting to overheat. Further, in various embodiments, the controller 120 may store temperature, voltage, and current histories, to ensure that the battery has not been mistreated prior to, or during, shipping.

In various embodiments, the controller 120 may receive health/tracking information from the battery 110. For example, the controller 120 may receive health tracking, history reports and/or safety indications from the battery 110. Further, the controller 120 may obtain additional information such as the temperature of battery 110, and unique identifiers of the battery 110. The controller 120 may be in communication with smoke, heat and flame detectors that may detect problems at the battery (not shown).

The controller 120 may store historical information received from the battery 110. For example, the controller 120 can be loaded with information about the battery 110 condition (e.g. age, use record, BMS records, collision history, state-of-charge changes). The controller 120 may store the battery 110 condition and can associate that information with the battery 110. In various embodiments, the battery monitor 115 may periodically (once a minute to once a day) interrogate the battery 110 and update the historical information stored regarding the battery 110. In an example embodiment, the controller 120 may be configured to store and maintain a record of the battery 110 internal voltages and temperatures. The controller 120 may be configured to determine the battery 110 capacity and remaining life based on the data received.

In various embodiments, the controller 120 may be configured to control the battery 110 when the battery 110 is disconnected from an EV. In various embodiments, the controller 120 may enable or disable the EV battery BMS (battery management system), enable or disable the EV battery main power output, enable or disable cell balancing mechanisms within the battery, or adjust safety thresholds within the EV battery BMS.

In various embodiments, the battery monitor 115 may comprise a communication device 150. The communication device 150 may be in communication with the controller 120. The communication device 150 may be a wireless communication device. For example, the communication device 150 may comprise a WWAN transmitter (e.g. cellular 4G or 5G communications link, or a satellite communications link) or a WLAN transmitter (e.g. Bluetooth, 802.11 or Zigbee). In various embodiments, the communication device 150 may transmit data to another device or an external network. For example, a user may use a smart phone to send data to and receive data from the battery monitor 115. Additionally, in various embodiments, an external user may remotely monitor the battery monitor 115 via the communication device 150.

In various embodiments, the communication device 150 may further comprise GPS tracking. For example, the communication device 150 may comprise GPS (or GLONASS, or other navigation receiver) to allow determination of position of the battery 110. In various embodiments, the communication device 150 may comprise GPS which will provide intermittent updates of the location of the battery 110. In various embodiments, the communication device 150 may use celestial GPS navigation. The controller 120 may be in communication with the communication device 150 and store data associated with the communication device. For example, the controller 120 may intermittently store information of the battery 110 location based on the communication device 150. Thus, the controller 120 may be configured to store historical location information for the battery 110.

In this example embodiment, the battery monitor 115 may be configured to facilitate tracking the physical location of each battery connected to a battery monitor 115. The battery monitor 115 may be configured to report the last known location of the battery, the route the battery took when shipped, temperature or other conditions during the shipping process, its state of charge at various times, and/or the like. Moreover, the battery monitor may be configured to provide any suitable localization related information for the connected battery. In addition, a user may utilize an application on a smartphone or other user interface to cause the battery monitor to trigger an audio/visual (light or tone) to help with identifying the connected battery from among a warehouse of monitored batteries.

In various embodiments, the battery monitor 115 may comprise an A/V warning 160. For example the A/V warning 160 may provide audio and/or visual alerts or indications. For example, the A/V warning 160 may indicate a potential problem with the battery 110, allowing early action to prevent fires and/or limit property damage due to fire. The A/V warning 160 may comprise a visual warning device, such as an indicator light. For example, the visual warning device may be an indicator light configured to be sufficiently bright to be identified in a warehouse even if there is no direct line of sight to the warning light, via reflections off walls or other batteries. Further, in various embodiments, the visual warning device may rapidly flash to indicate a warning, or slowly flash to indicate an identification. In an example embodiment, a connected device may receive information indicative that the connected battery is at risk (e.g., impending thermal runaway) and take action. The action may be, for example, to cause the identified battery to be removed from the warehouse, truck, train or other transportation device. The action may comprise arming a fire suppression system, evacuating an area, providing warnings or reports, or any other suitable safety action.

In various embodiments, the battery monitor 115 may comprise attached sensors 170 to determine other physical characteristics of the battery 110. In various embodiments, the sensor 170 may be in communication with the battery 110. In various embodiments, the sensor 170 may be in communication with the controller 120. In various embodiments, the sensor 170 may be configured to detect smoke, temperature, hydrogen, and/or other items associated with the battery 110. For example, in various embodiments, the sensor 170 may be a hydrogen detector. For example, the hydrogen detector may provide early warning that a battery is beginning to vent, which may indicate a problem with the battery. In various embodiments, the battery monitor 115 may comprise a sensor 170 including a particulate or ionization smoke detector. For example, the sensor 170 may be configured to include a particulate or ionization smoke detector which may provide warning that combustion has begun. In various embodiments, sensor 170 may include an infrared detector, which may provide early warning of overheating and/or provide a backup to internal temperature sensors. In various embodiments, the sensor 170 may be placed outside the battery monitor 115 so they can be in more direct contact with the battery.

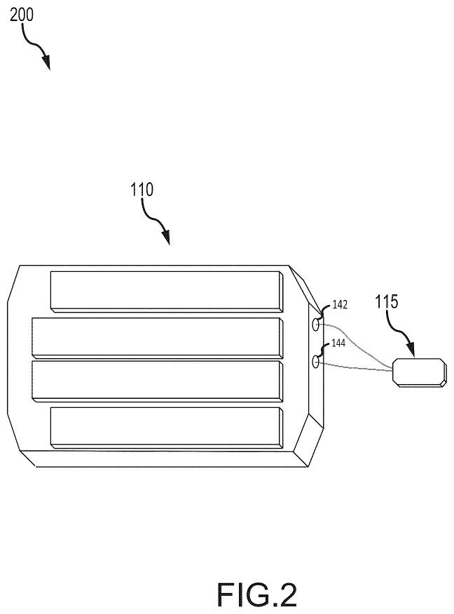

With reference now to FIG. 2, a three-dimensional rendering illustrating an example battery monitoring system 100, in accordance with various embodiments, is shown. In various embodiments, the battery monitor 115 may be detachable from the battery 110. The battery monitor 115 may be connected to the battery 110 by one or more connectors. The battery monitor 115 may be small enough to fit inside the casing of the battery 110. Alternatively, the battery monitor 115 may be small enough to fit inside the housing of a connector connected to either the power connector 142 or the communication port 144. In various embodiments, the battery monitor 115 may comprise sensor 170. For example, the sensor 170 may configured to detect temperature, smoke detection, and or hydrogen or other items associated with the battery 110, as described with reference to FIG. 1. In various embodiments, sensors 170 may be connected directly to the battery 110 by the one or more connections.

With reference to FIGS. 1 and 2, in various embodiments, the battery monitor 115 may provide power to the battery 110. For example, the battery monitor 115 may provide 12V to power connector 142 of the battery 110. In various embodiments, the battery monitor 115 may provide sequenced signals to the battery 110 to enable the battery 110. For example, the battery monitor 115 may send sequenced signals to the battery 110 to “wake up the battery 110. Accordingly, in response to the sequenced signals from the battery monitor 115, the battery controller of the battery 110 may allow communication from the data connector 114. For example, the battery controller of the battery 110 may allow two way communication from the CAN bus through the data connector 114. In various embodiments, the battery monitor 115 may receive signals or data from the battery 110. The controller 120 of the battery monitor 115 may determine the signals received from the battery 110. The controller 120 may determine if the signal, for example a CAN bus message, to check the state of health of the battery 110. In various embodiments, the controller 120 may report that the state of health of the battery 110 is good based on the determination of the signal received from the battery 110. The battery monitor 115 may enable the battery 110 to output a power supply based on the determination by the controller 120 of the state of health of the battery 110. The battery monitor 115 may enable the battery 110 and monitor that the correct impedance is output from the battery 110.

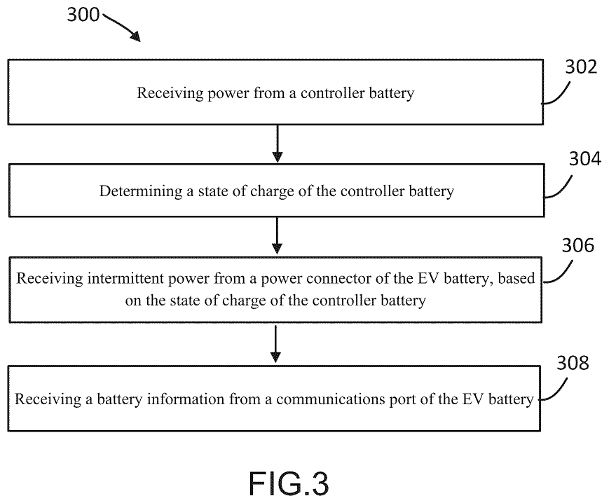

With reference now to FIG. 3, in accordance with an example embodiment, a method 300 of monitoring an EV battery is disclosed. In various embodiments, method 300) may include receiving, by a controller, power from a controller battery (step 302). In accordance with various embodiments, the method 300 may further include determining, by the controller, a state of charge of the controller battery (step 304). In accordance with various embodiments, the method 300 may further include receiving, by the controller, intermittent power from a power connector of the EV battery, based on the state of charge of the controller battery (step 306). In accordance with various embodiments, the method 300 may further include receiving, by the controller, battery information from a communications port of the EV battery (step 308).

In an example embodiment, the method 300 may further include controlling, by a controller, the EV battery. In various embodiments, the controlling the EV battery may be when the EV battery is disconnected from an EV. In various embodiments, the controlling the EV battery may include enabling or disabling the BMS of the EV battery, enabling or disabling the EV battery main power output of the EV battery, enabling or disabling cell balancing mechanisms of the EV battery, or adjusting safety thresholds of the BMS of the EV battery.

Example embodiments of the systems, methods, and devices described herein may be implemented in hardware, software, firmware, or some combination of hardware, software, and firmware. For example, the block and schematic diagrams of FIGS. 1-3 may be implemented in hardware, software, firmware, or some combination of hardware, software, and firmware.

In various embodiments, the modules discussed herein can be implemented as and may include one or more processors and/or one or more tangible, non-transitory memories (e.g., memory) and be capable of implementing logic. Each processor can be a general-purpose processor, a digital signal processor (“DSP”), an application specific integrated circuit (“ASIC”), a field programmable gate array (“FPGA”), or other programmable logic device, discrete gate or transistor logic, discrete hardware components, or any combination thereof. The controller can comprise a processor configured to implement various logical operations in response to execution of instructions, for example, instructions stored on a non-transitory, tangible, computer-readable medium configured to communicate with the modules discussed.

System program instructions and/or controller instructions can be loaded onto a non-transitory, tangible computer-readable medium of the modules having instructions stored thereon that, in response to execution by a processor of the modules, cause the modules to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In the present disclosure, the following terminology will be used: The singular forms “a.” “an.” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one exemplary embodiment of the disclosure and is not intended to limit the scope of the disclosure as described above.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed:

1. A battery monitoring system for monitoring an EV battery comprising:
a controller electrically connected to a communication port of the EV battery and a power connector of the EV battery; and
a controller battery electrically connected to the controller and the EV battery:
wherein the controller is configured to receive power from the controller battery; and
wherein the controller is configured to intermittently receive power from the power connector of the EV battery and to receive battery information from the communication port of the EV battery.

2. The battery monitoring system of claim 1, wherein the controller is configured to receive power and the battery information from the EV battery simultaneously.

3. The battery monitoring system of claim 1, wherein the controller is configured to receive power from the controller battery when the controller is not receiving power from the EV battery.

4. The battery monitoring system of claim 1, further comprising a power converter, the power converter for converting a high voltage from the EV battery to a lower voltage usable by the controller and the controller battery.

5. The battery monitoring system of claim 1, further comprising a location system configured to determine the location of the EV battery.

6. The battery monitoring system of claim 1, further comprising a communication device, the communication device configured to transmit the battery information.

7. The battery monitoring system of claim 1, further comprising a sensor, the sensor configured to detect changes in the EV battery.

8. A battery monitoring device for monitoring an EV battery comprising:
a controller electrically connected a communication port of the EV battery, a power connector of the EV battery, and a controller battery:
wherein the controller battery is configured to receive power from the power connector of the EV battery:
wherein the controller is configured to receive power from the controller battery and intermittently receive power from the power connector of the EV battery; and
wherein the controller is configured to receive battery information from the communication port of the EV battery.

9. The battery monitoring device of claim 8, wherein the controller is configured receive power and the battery information from the EV battery simultaneously.

10. The battery monitoring device of claim 8, wherein the controller is configured to receive power from the controller battery when the controller is not receiving power from the EV battery.

11. The battery monitoring device of claim 8, further comprising a power converter, the power converter for converting a high voltage from the EV battery to a lower voltage usable by the controller and the controller battery.

12. The battery monitoring device of claim 8, further comprising a location system configured to determine the location of the EV battery.

13. The battery monitoring device of claim 8, further comprising a communication device, the communication device configured to transmit the battery information.

14. The battery monitoring device of claim 8, further comprising a sensor, the sensor configured to detect changes in the EV battery.

15. A method of monitoring an EV battery comprising:
receiving, by a controller, power from a controller battery:
determining, by the controller, a state of charge of the controller battery:
receiving, by the controller, intermittent power from a power connector of the EV battery, based on the state of charge of the controller battery; and
receiving, by the controller, a battery information from a communications port of the EV battery.

16. The method of monitoring an EV battery of claim 15, wherein the receiving intermittent power from the EV battery and receiving the battery information from the EV battery is done simultaneously.

17. The method of monitoring an EV battery of claim 15, wherein the controller is configured to receive power from the controller battery when the controller is not receiving power from the EV battery.

18. The method of monitoring an EV battery of claim 15, wherein the receiving, by the controller, intermittent power from the power connector of the EV battery comprises:
converting, by a power converter, the power received from the EV battery from a high voltage to a lower voltage usable by the controller.

19. The method of monitoring an EV battery of claim 15, further comprising:
storing, by the controller, the battery information; and
transmitting, by a communication device, the battery information.

20. The method of monitoring an EV battery of claim 15, further comprising:
controlling, by the controller, the EV battery.
